(19) United States
(12) Patent Application Publication
(10) Pub. No.: US 2013/0187791 A1
(43) Pub. Date: Jul. 25, 2013

(54) ELECTRONIC PAPER HOUR METER OR CYCLE COUNTER

(71) Applicants: David C. Marcus, San Diego, CA (US); Charles R. Gilbreth, San Diego, CA (US); Eugene L. Peterson, Jamul, CA (US)

(72) Inventors: David C. Marcus, San Diego, CA (US); Charles R. Gilbreth, San Diego, CA (US); Eugene L. Peterson, Jamul, CA (US)

(73) Assignee: HAMILTON SUNDSTRAND CORPORATION, Windsor Locks, CT (US)

(21) Appl. No.: 13/354,572

(22) Filed: Jan. 20, 2012

(51) Int. Cl. H04Q 9/00

(52) U.S. Cl. 340/870.07

(57) ABSTRACT

A device for monitoring a physical system includes an interface in operable communication with the physical system and a control circuit in operable communication with the interface. The device also includes a memory in operable communication with the control circuitry and an electronic paper display in operable communication with the control circuitry. The electronic paper display continuously displays information related to the operation of the physical system.

### BACKGROUND OF THE INVENTION

The present disclosure relates to hour meters and cycle counters, and more specifically, to hour meters and cycle counters with an electronic paper display.

Hour meters and cycle counters are employed in applications ranging from airplanes to generators and are used for warranty and maintenance scheduling in both combustion and electric motors to track use of the motors. Hour meters come in a variety of forms, and are able to track usage time in various ways. One of the most common applications for an engine hour meter is in aviation. Airplanes require strict maintenance based on run time and hour meters effectively fill that need. One of the earliest hour meters developed by Hobbs is still commonly used today.

Hour meters are currently available in both analog and digital styles. Analog meters function much like a simplified watch, and they are very reliable and easy to read. In addition, analog meters are commonly made in brass to help deal with extreme operating environments. In many cases, for maintenance and inspections purposes, hour meters or cycle counters are required to have displays that are always readable, even when there is no power to the meter. However, currently available digital meters require an additional power source to power the display.

### BRIEF DESCRIPTION OF THE INVENTION

In an exemplary embodiment, a device for monitoring a physical system includes an interface in operable communication with the physical system and a control circuit in operable communication with the interface. The device also includes a memory in operable communication with the control circuitry and an electronic paper display in operable communication with the control circuitry. In this embodiment, the electronic paper display continuously displays information related to the operation of the physical system.

In another exemplary embodiment, a device for monitoring a physical system includes an interface in operable communication with the physical system. In this embodiment, the interface receives information related to the operation of the physical system. The device also includes a control circuit in operable communication with the interface and a memory in operable communication with the control circuitry that stores the information related to the operation of the physical system. The system also includes an electronic paper display in operable communication with the control circuitry and that continuously displays information related to the operation of the physical system.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of a device for monitoring a physical system in accordance with an embodiment of the disclosure;

FIG. 2 is a front view of a device for monitoring a physical system in accordance with an embodiment of the disclosure;

FIG. 3 is a flow chart illustrating the operation of a device for monitoring a usage time for a physical system in accordance with an embodiment of the disclosure; and

FIG. 4 is a flow chart illustrating the operation of a device for monitoring a cycle count of a physical system in accordance with another embodiment of the disclosure.

### DETAILED DESCRIPTION OF THE INVENTION

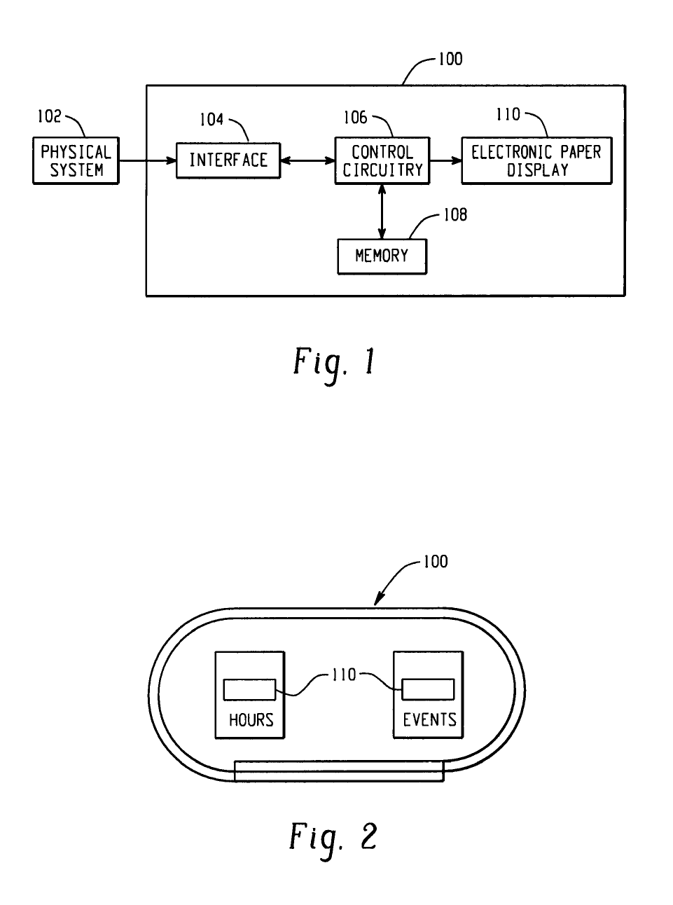

Referring to FIG. 1, a block diagram of a device 100 for monitoring a physical system 102 in accordance with an embodiment of the disclosure is shown. The device 100 includes an interface 104, a control circuitry 106, a memory 108, and an electronic paper display 110. The interface 104 is designed to connect the device 100 to the physical system 102 and to receive one or both of power and operational data from the physical system 102. The control circuitry 106 receives the operational data from the interface 104 and updates the electronic paper display 110 accordingly. The electronic paper display 110 continuously displays one or more pieces of information related to the operation of the physical system 102. In addition, the control circuitry 106 uses the memory 108 to store operational data received from the physical system 102. In exemplary embodiments, the memory 108 is a non-volatile memory that retains the stored information when there is no power provided to or supplied by the device 100. In an exemplary embodiment, the device 100 utilizes an electrical system of the physical system 102, but requires no other power source to operate or to sustain the electronic paper display 110.

Continuing now with reference to FIG. 2, a front view of a device 100 for monitoring a physical system in accordance with an exemplary embodiment is shown. The device 100 includes two electronic paper displays 110. As shown, one of the electronic paper displays 110 can be used to display an hour count of the physical system and the other electronic paper display 110 can be used to display a cycle count of the physical system. In exemplary embodiments, the device 100 can be designed to include only one electronic paper display 110 designed to show multiple pieces of information related to the operation of the physical system. In another exemplary embodiment, the device 100 can be designed to include multiple electronic paper displays 110, each designed to show a single piece of information related to the operation of the physical system. It shall be further understood that other embodiments can include any combination of the above described displays.

In exemplary embodiments, the electronic paper display 110 may be an electrophoretic display that forms visible images by rearranging charged pigment particles using an applied electric field. For example, the electrophoretic display can include capsules that are filled with electrically charged white particles that are suspended in colored oil. In one embodiment, the control circuitry 106 may be used to control the appearance of the electronic paper display 110. For example, by positioning the white particles at the top of the capsule, that portion of the display appears to be white to the user. Likewise, by placing the white particles at the bottom of the capsule, that portion of the display appears to be colored to the user. In exemplary embodiments, the electronic paper display 110 can be used on a flexible plastic sheet or on glass.

In one embodiment, the electronic paper display 110 may be an electrophoretic display that includes an array of transparent capsules that each contain an oily solution including black dye and negatively charged white titanium dioxide particles suspended in the oily solution. The capsules are held in a layer of liquid polymer, in-between two arrays of electrodes, the upper array of electrode is designed to be transparent. The two electrode arrays are aligned so that the display is divided into pixels, which each pixel corresponding to a pair of electrodes situated on either side of the display. The network of electrodes is connected to the control circuitry 106 (FIG. 1), which controls the appearance of the electrophoretic display by applying a voltage to specific pairs of electrodes. It will be appreciated by those of ordinary skill in the art that the electronic paper display 110 may be an electrophoretic display, an electrowetting display, or any other suitable display that is capable of maintaining readability without a constant power supply.

Referring now to both FIGS. 1 and 2, in exemplary embodiments, the electronic paper display 110 of the device 100 continuously displays information related to the operation of the physical system 100 even when there is no power being provided to the device 100 or the electronic paper display 110. The electronic paper display 110 can be used to display an hour count and/or a cycle count of the physical system 102. For example, if the physical system 102 is an airplane the device 100 may be used to monitor the amount of time the plane has been in flight, the number of take-offs or landings, or other information relating to the use of the airplane.

In exemplary embodiments, the control circuitry 106 and the interface 104 may use a variety of methods to monitor the physical system 102. For example, the control circuitry 106 may monitor the amount of time that a master switch in the physical system 102 is in the on position. In another embodiment, the control circuitry 106 and the interface 104 may monitor a specific characteristic of the physical system 102 to determine if the physical system 102 is in use, such as monitoring an oil pressure switch. In other embodiments, the control circuitry 106 and the interface 104 can be designed to monitor the position of various other switches in the physical system 102, such as an airspeed sensing vane or a pressure switch attached to the landing gear.

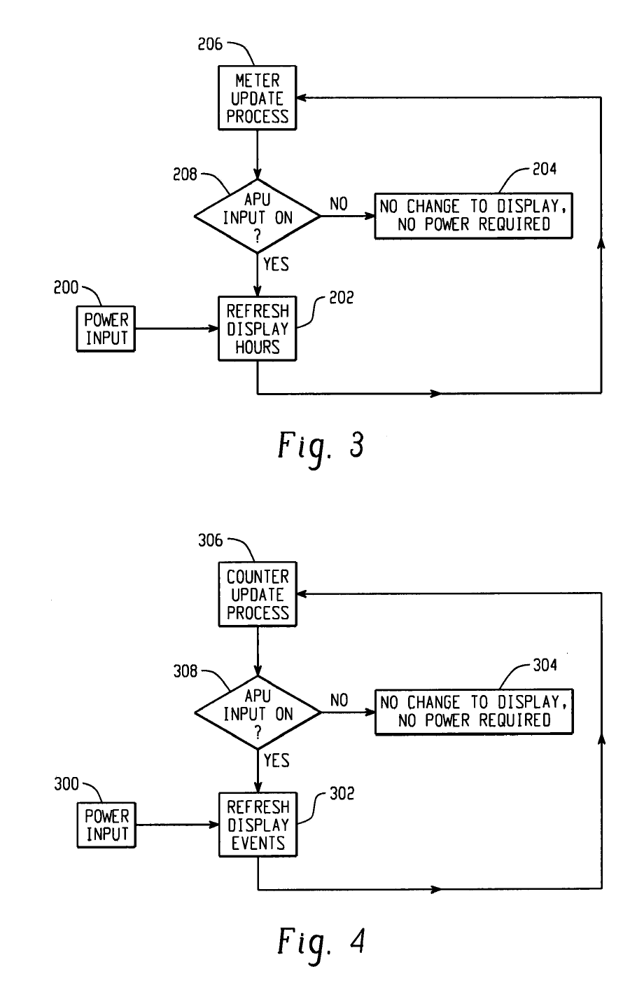

Referring now to FIG. 3, a flow chart illustrating the operation of a device for monitoring a usage time for a physical system is shown. As shown at block 200, the device receives power from the physical system. When the device is receiving power, the display is refreshed to update the number of hours displayed, as shown at block 202. At block 206, the control circuitry of the device is used to update the memory of the device. At decision block 208, the device determines if the physical system is in use. If so, the display is refreshed as shown at block 202. If the physical system is not in use, the display is not updated, as shown at block 204. The device continues to display the present value of number of hours information even in the absence of electrical power. In this example, the physical system is an engine of an auxiliary power unit (APU) on an aircraft, and the device displays the number of hours that the engine has been in use.

Referring now to FIG. 4, a flow chart illustrating the operation of a device for monitoring a cycle count for a physical system is shown. As shown at block 300, the device receives power from the physical system. When the device is receiving power, the display is refreshed to update the cycle count displayed, as shown at block 302. At block 306, the control circuitry of the device is used to update the memory of the device. At decision block 308, the device determines if the physical system is in use. If so, the display may be refreshed as shown at block 302. If the physical system is not in use, the display is not updated, as shown at block 304. The device continues to display the present value of cycle count information even in the absence of electrical power. In this example, the physical system is an engine of an APU on an aircraft, and the device displays the number of cycles or flights that the physical system has completed.

Referring again to FIG. 1, because the electronic paper display 110 does not require sustaining power to retain the display, the electronic paper display 110 can be read by an operator at any time, even when the device 100 or electronic paper display 110 have no power. Accordingly, the electronic paper display 110 produces the same effect as the mechanical dial and is always able to be read for maintenance and inspection purposes. In exemplary embodiments, the device 100 can be designed to withstand aerospace environments with Radio Technical Commission for Aeronautics DO-160 qualification.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The flow diagrams depicted herein are just one example. There may be many variations to this diagram or the steps (or operations) described therein without departing from the spirit of the disclosure. For instance, the steps may be performed in a differing order or steps may be added, deleted or modified. All of these variations are considered a part of the claimed disclosure.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated

While the preferred embodiment to the disclosure had been described, it will be understood that those skilled in the art, both now and in the future, may make various improvements and enhancements which fall within the scope of the claims which follow. These claims should be construed to maintain the proper protection for the disclosure first described.

1. A device for monitoring a physical system, comprising:
an interface in operable communication with the physical system;
a control circuit in operable communication with the interface;
a memory in operable communication with the control circuitry; and
an electronic paper display in operable communication with the control circuitry, wherein the electronic paper display continuously displays information related to the operation of the physical system.

2. The device for monitoring a physical system of claim 1, wherein the physical system is an engine and the information related to the operation of the engine is a number of hours the engine has been in use.

3. The device for monitoring a physical system of claim 1, wherein the physical system comprises a power source in operable communication with the interface.

4. The device for monitoring a physical system of claim 3, wherein the electronic paper display is updated by the control circuit when the power source is active.

5. The device for monitoring a physical system of claim 1, wherein the information related to the operation of the physical system is a number of cycles that the physical system has completed.

6. The device for monitoring a physical system of claim 3, wherein the control circuit updates the electronic paper display when the power source is active.

7. The device for monitoring a physical system of claim 1, wherein the memory stores information related to the operation of the physical system.

8. The device for monitoring a physical system of claim 7, wherein the memory is a non-volatile memory.

9. The device for monitoring a physical system of claim 3, wherein the control circuitry updates the memory when the power source is active.

10. The device for monitoring a physical system of claim 3, wherein the electronic paper display displays information related to the operation of the physical system when the power source is inactive.

11. A device for monitoring a physical system, comprising:
an interface in operable communication with the physical system, wherein the interface receives information related to the operation of the physical system;
a control circuit in operable communication with the interface;
a memory in operable communication with the control circuitry, wherein the memory stores the information related to the operation of the physical system; and
an electronic paper display in operable communication with the control circuitry, wherein the electronic paper display continuously displays information related to the operation of the physical system.

12. The device for monitoring a physical system of claim 11, wherein the interface receives power from a power source in the physical system.

13. The device for monitoring a physical system of claim 11, wherein the electronic paper display is updated by the control circuit when the power source is active.

14. The device for monitoring a physical system of claim 11, wherein the information related to the operation of the physical system is a number of hours the physical system has been in use.

15. The device for monitoring a physical system of claim 10, wherein the information related to the operation of the physical system is a cycle count of the physical system.

16. The device for monitoring a physical system of claim 11, wherein the physical system is an aircraft and the information related to the operation of the physical system is a number of hours the aircraft has been in use.

17. The device for monitoring a physical system of claim 11, wherein the physical system is an aircraft and the information related to the operation of the physical system is a number of flights the aircraft has completed.
